(19) United States
(12) Patent Application Publication
(10) Pub. No.: US 2011/0284803 A1
(43) Pub. Date: Nov. 24, 2011

(54) Method for sorting nanoobjects and an apparatus fabricated thereby

(76) Inventor: Vladimir Y. Butko, St. Petersburg (RU)

(21) Appl. No.: 13/147,767

(22) PCT Filed: Jan. 27, 2010
(86) PCT No.: PCT/RU10/00030

§ 371 Date: Aug. 3, 2011

(30) Foreign Application Priority Data
Feb. 3, 2009 (RU) 2009103926
Jan. 20, 2010 (US) 12690873

(51) Int. Cl. B03C 9/00; H01B 1/04; B82Y 99/00

(52) U.S. Cl. 252/502; 209/3.1; 977/932; 977/742

(57) ABSTRACT

A method for sorting nanoobjects from the mixture comprising nanoobjects such as semiconducting and metallic carbon nanotubes and an apparatus fabricated thereby. An embodiment comprises an energy transfer to the mixture in a way that the degree in which nanoonobjects are heated and bonded to the surface of a substance depends on their electrical conductivities. The next embodiment comprises an electrolytic deposition of a material on the mixture in a way that the degree in which nanoanobjects are bonded to the surface of the substance by the deposited layer depends on their electrical conductivities. The above nanoobjects are sorted by selectively separating mostly the weaker bonded nanoobjects from the surface. Another embodiment comprises an energy transfer in a low pressure reactive gas medium to the mixture in a way that the degree in which nanoonobjects are heated and chemically modified depends on their conductivities.

### CROSS REFERENCE TO RELATED APPLICATIONS

(Related applications may be listed on an application data sheet, either instead of or together with being listed in the specification.)

The priority date for this Patent Application should be established on the basis of the priority date of the “parent” Russian Patent Application 2009103926 filed at the Federal Institute of Industrial Property (Russian Patent Office) on Feb. 3, 2009. Application for this invention was also filed as a U.S. patent application Ser. No. 12/690,873 on Jan. 20, 2010.

Other references:
1) U.S. Pat. No. 6,423,583 Jul. 23, 2002
2) US Patent Application 20060065887
3) U.S. Pat. No. 7,150,865 Dec. 19, 2006
4) US Patent Application 20070085460
5) US Patent Application 20060278579
6) US Patent Application 20040173378

### STATEMENT OF FEDERALLY SPONSORED RESEARCH/DEVELOPMENT (IF ANY)

### REFERENCE TO A “SEQUENCE LISTING,”.

None

### BACKGROUND OF THE INVENTION

Nanoobjects (objects with at least one spatial size in the range from 0.05 nm to 500 nm), including carbon nanotubes demonstrate a number of unique properties, and are important for industrial applications. In particular for semiconductor apparatus it is important to obtain semiconducting active components without any metallic inclusions such as metallic nanotubes to prevent an electrical shortage. On the other hand for fabrication of metallic components of an apparatus such as contacts and electrodes it is preferable to use pure metallic nanoobjects. Therefore to realize the full potential of carbon nanotubes methods that are capable of obtaining them in large quantities with uniform properties are required. However this problem has not been solved in previous studies. Methods that have been proposed to solve this problem include the following: destroying metallic nanotubes by electrical current (U.S. Pat. No. 6,423,583 Jul. 23, 2002, US Patent Application 20060065887), destroying metallic nanotubes by microwave radiation in air (U.S. Pat. No. 7,150,865 Dec. 19, 2006 and US patent application 20070085460), and by selectively plating the metallic carbon nanotubes to precipitate the metallic carbon nanotubes from the solutions (US patent applications 20060278579, and 20040173378). One of the main disadvantages of the first two methods is the high temperatures of the nanotubes required in these methods. The high temperatures results in severe damage to almost all nanoobjects in the process. The main disadvantage of the third method is the low efficiency of the sorting in this process and a requirement of using an electroless plating solution for the precipitation.

### BRIEF SUMMARY OF THE INVENTION

This invention is related to nanothechnology and more precisely to methods for sorting nanoobjects, such as semiconducting and metallic nanotubes. The method claimed here fundamentally does not have the mentioned above disadvantages and opens new opportunities in solving the problem of sorting nanoobjects with different electrical conductivities. In particularly this method's embodiments do not require exposing nanoobjects to the high temperatures as in the two mentioned destructive methods.

### INVENTION EXAMPLES

In one embodiment (referred to below as the first type of embodiments), the method of claim 1 is used. In one non-limiting example (FIG. 1), the method for sorting semiconducting and metallic carbon nanotubes, comprising the steps of: a) providing contact between an initial mixture that comprises the nanotubes and a surface of a solid or a soft organic substance; b) providing an energy transfer by microwave radiation to the said mixture with the amount of heat per unit of time obtained by the semiconducting and the metallic nanotubes dependent on their electrical conductivities, while keeping at least some part of the contacting substance for at least some nonzero period of time during the energy transfer at a temperature (T) such that condition (1) of claim 1 (see below) is fulfilled, leading to the situation where at least some of the nanotubes after the start of the energy transfer are bonded to the contacting surface with an average strength of this bonding dependent on the nanoobjects electrical conductivities (this bonding is due to physical means related to melting and (following) crystallizing a part of the substance around the heated nanotubes, and a portion of the semiconducting nanotubes among the weaker bonded carbon nanotubes and non-bonded carbon nanotubes is bigger than in the initial mixture); c) selectively separating mostly the weaker bonded and non-bonded nanotubes from the surface; and d) obtaining at least one product that comprises the nanotubes with an average electrical conductivity that is different from the average electrical conductivity of the nanoobjects in the initial mixture.

Condition (1) of claim 1 in this example is formulated as the following: the absolute difference between T and a melting transition temperature (Tₘ) of a part of the contacting substance, is less than a maximal absolute difference between temperatures of any parts of the nanotubes (ΔT) at the surface during the energy transfer (|Tₘ−T|<ΔT). (This condition needs to be fulfilled to realize a situation where the temperature of the most heated nanotubes is high enough to melt the part of the substance around them, while the least heated nanotubes have not reached this temperature).
Conditions (2), (3), (4) of the claim 1 in the first type of embodiments have analogous meaning in respect to the evaporation of a part of the contacting substance, activation of a chemical reaction that involves a part of the contacting substance, and an activation of a chemical reaction that involves the nanoobjects, correspondingly.

In another embodiment (referred to below as the second type of embodiments), the method of claim 21 is used. In one non-limiting example (FIG. 2), the method for sorting semiconducting and metallic carbon nanotubes, comprising the steps of: a) providing a placement of an initial mixture that comprises the nanotubes with different electrical conductivities into an oxygen gas under pressure that is significantly lower than the normal atmospheric pressure (the pressure is less than 50 kPa); b) providing an energy transfer to the said mixture by microwave radiation with an amount of heat per unit of time obtained by the nanotubes dependent on their electrical conductivities wherein at least some part of the oxygen gas for at least some (nonzero) period of time during the energy transfer is kept at a temperature such that the absolute difference between this temperature and an activation temperature of a chemical reaction that involves the carbon nanotubes and the oxygen gas is less than a maximal absolute difference between temperatures of any parts of the nanotubes after the start of the energy transfer, providing this energy transfer at least before some of the heated nanoonobjects are modified to a gas form; and c) obtaining at least one product that comprises the nanoobjects with a portion of the semiconducting nanoobjects that is significantly bigger than the portion of the semiconducting nanoobjects in the initial mixture.

The second type of embodiments uses a low gas pressure that is primarily selected to decrease the heat exchange between nanoobjects, improving the selectiveness of the heating process. (The high temperature results in a big damage to almost all nanoobjects in the process).

In another embodiment (referred to below as the third type of embodiments), the method of claim 35 is used. In one non-limiting example (FIG. 3), the method for sorting semiconducting and metallic carbon nanotubes, comprising the steps of: a) providing a contact between an initial mixture that comprises the nanotubes with different electrical conductivities and an electrical conducting surface of a solid substance; b) providing an electroplating deposition of Ni in an electrolyte while driving an electrical current through the said contact at least during some (nonzero) period of time during this deposition with the thickness of the Ni layer deposited per unit of time on the nanotubes dependent on their electrical conductivities at least before some of the nanotubes are bonded by the Ni layer to the conducting surface with an average strength of this bonding dependent on the nanotubes electrical conductivities; c) selectively separating mostly the weaker bonded and non-bonded nanotubes from the surface; and d) obtaining at least one product that comprises the nanotubes with an average electrical conductivity that is different from the average electrical conductivity of the nanotubes in the initial mixture.

### BRIEF DESCRIPTION OF THE SEVERAL VIEWS OF THE DRAWING (IF ANY)

FIG. 1 depicts a non-limiting example of the method and an apparatus fabricated thereby according to the first type of embodiments of the present invention.

FIG. 2 depicts a non-limiting example of the method and an apparatus fabricated thereby according to the second type of embodiments of the present invention.

FIG. 3 depicts a non-limiting example of the method and an apparatus fabricated thereby according to the third type of embodiments of the present invention.

### DETAILED DESCRIPTION OF THE INVENTION

### Expression Meaning

1) The expression ‘soft matter’ and any variations thereof used in the claims and in the description, is intended to include any substance at least some part of which has been brought at least for some period of time during the sorting process to a state with mechanical properties that are intermediate between typical properties of solid matter and liquid matter.

2) The expression ‘heat’ and any variations thereof used in the claims and in the description, is intended to include an increase in internal energy of objects or materials related to atomic and molecular movement that should also be understood as a temperature increase in an equilibrium case and as an increase of a local quasi temperature in a non-equilibrium case.

3) The expression ‘contact’ and any variations thereof used in the claims and in the description, is intended to include an existence of a common interface between any part of the substance and the nanoobject.

4) The expression ‘separating the nanoobjects from the surface’ and any variations thereof used in the claims and in the description, is intended to include a process or an act of providing separation between the nanoobjects and the substance part that before the separation interfaced the nanoobjects.

5) The expression ‘microwave radiation’ and any variations thereof used in the claims and in the description, is intended to include an electromagnetic radiation in a frequency range 1 GHz-300 GHz.

6) The expression ‘far infrared radiation’ and any variations thereof used in the claims and in the description, is intended to include an electromagnetic radiation in a frequency range 300 GHz-200 THz.

7) The expression ‘melting transition temperature’ and any variations thereof used in the claims and in the description, is intended to include a temperature of a phase transition from a solid to a liquid phase as well a temperature above which a soft matter becomes essentially a liquid.

8) The expression ‘evaporation’ and any variations thereof used in the claims and in the description, is intended to include a phase transition to a gas phase from any of the following phases: solid, liquid, or soft matter.

### Embodiments of the Present Invention

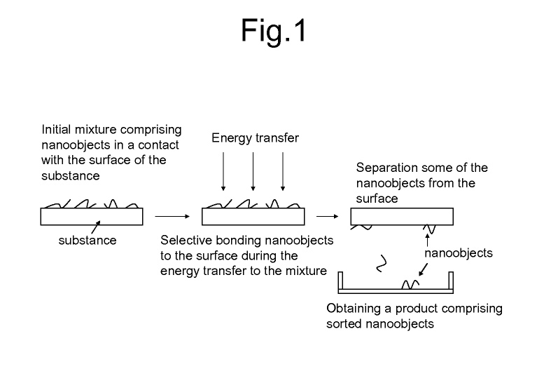

### A. Non-Limiting Examples of the First Type of Embodiments (Claims 1-20, FIG. 1)

(1) The method, further comprising the steps of: providing a purification of the mixture from metallic inclusions, providing at least a partial separation of the stacked together carbon nanotubes, and providing the contact between the nanoobjects and the surface of the substance by at least one of the means selected from the group consisting of: a mechanical force, a gravitational force, and an inertia.

(2) The method, wherein the surface of the substance has a shape with a high ratio (not less than 1.5) of the surface area to the surface area of a flat geometrical figure with the same overall length and width.

(3) The method, wherein the separation of the weaker bonded and non-bonded nanoobjects from the surface is conducted by using at least one process from the group consisting of a separation by a gas flow, a separation by a liquid flow, a separation by an ultrasonication, a separation by an electrostatic force, a separation by a magnetic force, a separation by a gravitational force, a separation by an inertial force, a separation by dissolving other components, a separation by evaporating other components, and by any combination thereof.

(4) The method, wherein the energy transfer at least includes transferring energy in a form selected from the group consisting of: an electromagnetic radiation in the frequency range from 100 MHz to 400 THz, an energy transfer from an electrical source by a direct electrical current that provides heat, an energy transfer from an electrical source by an alternating electrical current that provides heat, and any combinations thereof.

(5) The method, wherein the weaker bonded carbon nanotubes and non-bonded carbon nanotubes comprises a bigger than average portion of the semiconducting carbon nanotubes.

(6) The method, wherein at least some part of the substance surface during the energy transfer at least once changes its phase from one phase from the group consisting of: a solid phase, and a liquid phase to another phase from the same group, and the bonding is due to physical means related to melting and crystallizing part of the substance near the heated nanoobjects.

(7) The method, wherein the surface of the substance comprises an inorganic material.

(8) The method, wherein the energy transfer at least includes transferring energy in a form selected from the group consisting of: a microwave electromagnetic radiation, a far infrared electromagnetic radiation, and a narrow (narrow compared to an energetic difference between electronic levels in the nanoobjects) bandwidth electromagnetic radiation.

(9) The method, wherein a portion of the semiconducting nanotubes among the weaker bonded carbon nanotubes and non-bonded carbon nanotubes is bigger than in the initial mixture.

(10) The apparatus wherein i) the method further comprising the steps of: providing a purification of the mixture from metallic inclusions, providing at least a partial separation of the stacked together carbon nanotubes, and providing the contact between the mixture that contains nanoobjects and the surface of the substance by at least one of the means selected from the group consisting of: a mechanical force, a gravitational force, an inertial force; and ii) the device for sorting nanoobjects, further comprises: a component providing a purification of the mixture from metallic inclusions, a component providing at least a partial separation of the stacked together carbon nanotubes, and a component providing the contact between the mixture that contains nanoobjects and the surface of the substance by at least one of the means selected from the group consisting of: a mechanical force, a gravitational force, an inertial force.

(11) The apparatus, wherein i) the method further comprises the non-limiting examples (1)-(10); and ii) the device for sorting nanoobjects further comprises: components which provide realization of the non-limiting examples (1)-(10).

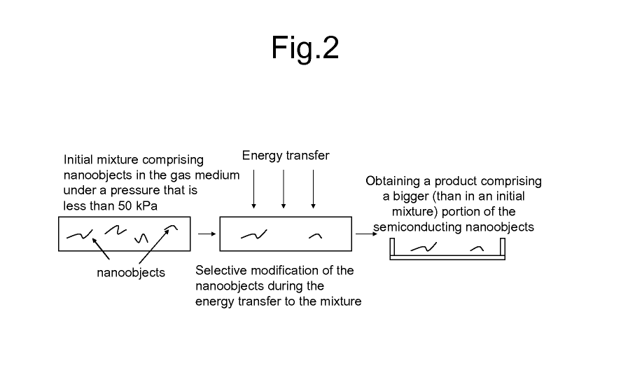

### B. Non-Limiting Examples of the Second Type of Embodiments (Claims 21-34, FIG. 2)

(1) The method, further comprising the steps of: providing a purification of the mixture from metallic inclusions, and providing at least a partial separation of the stacked together carbon nanotubes.

(2) The method, wherein the energy transfer at least includes transferring energy by a narrow (narrow compared to an energetic difference between electronic levels in the nanoobjects) bandwidth electromagnetic radiation with a photon energy at the edge of resonance electron transitions in the nanoobjects in the frequency range from 100 MHz to 400 THz.

(3) The apparatus, wherein i) the method further comprises the non-limiting examples (1)-(12); and ii) the device for sorting nanoobjects further comprises: components which provide realization of the non-limiting examples (1)-(2).

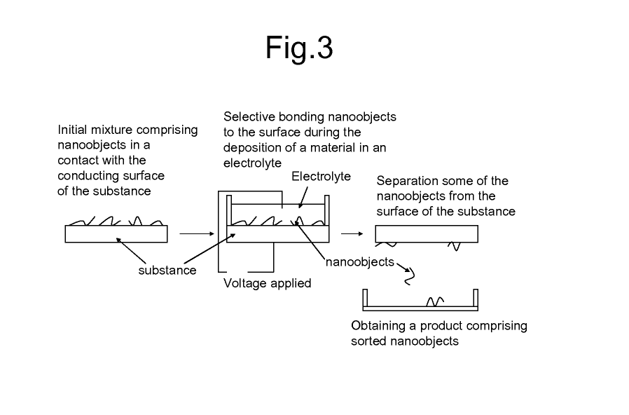

### C. Non-Limiting Examples of the Third Type of Embodiments (Claims 35-42, FIG. 3)

(1) The method, further comprising the steps of: providing the fixed contact by at least one of the means selected from the group consisting of: a mechanical force, a gravitational force, and an inertial force.

(2) The method, wherein the electrical conducting surface, the material, and the electrolyte comprises at least one chemical element from the group consisting of: a alkali metal, an alkaline earth metal, C, H, Si, As, Ga, In, Sb, Cu, Au, Pd, Pt, Ag, Al, Ni, Co, Fe, Sn, Zn, Hg, Pb, and any combinations thereof.

(3) The method, wherein a portion of the semiconducting nanotubes among the weaker bonded carbon nanotubes and non-bonded carbon nanotubes is bigger than in the initial mixture.

(4) The method, wherein the conducting surface of the substance has a shape with a high ratio (not less than 1.5) of the surface area to the surface area of a flat geometrical figure with the same overall length and width.

(5) The method, wherein the separation of the weaker bonded and non-bonded nanoobjects from the surface is conducted by using at least one process from the group consisting of a separation by a gas flow, a separation by a liquid flow, a separation by an ultrasonication, a separation by an electrostatic force, a separation by a magnetic force, a separation by a gravitational force, a separation by an inertial force, a separation by dissolving other components, a separation by evaporating other components, and by any combination thereof.

(6) The method, wherein the weaker bonded carbon nanotubes and non-bonded carbon nanotubes comprises a bigger than average portion of the semiconducting carbon nanotubes.

(7) The apparatus, wherein i) the method further comprises the non-limiting examples (1)-(6); and ii) the device for sorting nanoobjects further comprises: components which provide realization of the non-limiting examples (1)-(6).

### Remarks

It will be understood that, although the terms first, second, third etc. may be used herein to describe the embodiments these terms are only used for illustrative purposes. As used herein, the singular forms ‘a’, ‘an’ and ‘the’ are intended to include the plural forms as well, unless the context clearly indicates otherwise. It will be further understood that the terms ‘comprises’ and ‘comprising,’ when used in this specification, specify the presence of stated features, integers, steps, operations, elements, or components, but do not preclude the presence or addition of one or more other features, integers, steps, operations, elements, components, or groups thereof. Example embodiments of the present invention are described herein with reference to figures that are schematic illustrations of idealized embodiments of the present invention. As such, variations from the shapes and sizes of the illustrations are to be expected. The present invention may be embodied in many different forms and should not be construed as limited to the embodiments set forth herein. Unless otherwise defined, all terms and expressions (including technical and scientific terms) used herein have the same meaning as commonly understood by one of ordinary skill in the art to which the present invention belongs. It will be further understood that terms and expressions, such as those defined in commonly used dictionaries, should be interpreted as having a meaning that is consistent with their meaning in the context of the relevant art and will not be interpreted in an idealized or overly formal sense unless expressly so defined herein. Although example embodiments of the present invention have been disclosed for illustrative purposes, those skilled in the art will appreciate that various modifications, additions and substitutions are possible, without departing from the scope and spirit of the invention as disclosed in the accompanying claims. Variations, modifications, and other implementations of what is described herein will occur to those of ordinary skill in the art without departing from the spirit and scope of the invention as claimed.

We claim:

1. A method for sorting nanoobjects (objects with at least one spatial size in the range from 0.05 nm to 500 nm), comprising the steps of:
a) providing contact between an initial mixture that comprises the nanoobjects with different electrical conductivities and a surface of a substance selected from the group consisting of: a solid, a liquid, a soft matter, and any combinations thereof;
b) providing an energy transfer to the said mixture with an amount of heat per unit of time obtained by the nanoonobjects dependent on their electrical conductivities, and keeping at least some part of the contacting substance for at least some nonzero period of time during the energy transfer at a temperature (T) such that at least one condition is fulfilled from the group of conditions consisting of:
(1) the absolute difference between T and a melting transition temperature (Tₘ) of a part of the contacting substance, is less than a maximal absolute difference between temperatures of any parts of the nanoobjects (ΔT) at the surface during the energy transfer (|Tₘ−T|<ΔT),
(2) the absolute difference between T and an evaporation transition temperature (Tₑ) of a part of the contacting substance, is less than ΔT (|Tₑ−T|<ΔT),
(3) the absolute difference between T and an activation temperature of a chemical reaction that involves a part of the contacting substance (Tₑₛ), is less than ΔT (|Tₑₛ−T|<ΔT),
(4) the absolute difference between T and an activation temperature of a chemical reaction that involves the nanoobjects (Tₑₙ), is less than ΔT (|Tₑₙ−T|<ΔT);
and at least some of the nanoonobjects after the start of the energy transfer are bonded to the contacting surface with an average strength of this bonding dependent on the nanoobjects electrical conductivities;
c) selectively separating mostly the weaker bonded and non-bonded nanoobjects from the surface; and
d) obtaining at least one product that comprises the nanoobjects with an average electrical conductivity that is different from the average electrical conductivity of the nanoobjects in the initial mixture.

2. The method of claim 1, wherein the mixture comprises at least one semiconducting carbon nanotube.

3. The method of claim 1, wherein at least some part of the substance for at least some nonzero time period during the energy transfer at least once changes its phase from one phase from the group consisting of: a solid phase, a liquid phase, and a vapor phase, to another phase from the same group.

4. The method of claim 2, wherein at least some part of the substance during the energy transfer at least one time changes its phase from one phase from the group consisting of: a solid phase, a liquid phase, and a vapor phase, to another phase from the same group, and at least some part of the substance for at least some nonzero period of time during the energy transfer is kept at a temperature such that the difference between this temperature and at least one temperature selected from the group consisting of: a melting transition temperature of a part of the substance, and an evaporation transition temperature of a part of the substance, is not more than a maximal difference between temperatures of any parts of the carbon nanotubes during energy transfer.

5. The method of claim 2, wherein at least some part of the substance during the energy transfer at least once changes its phase from one phase from the group consisting of: a solid phase, and a liquid phase to another phase from the same group.

6. The method of claim 2, wherein the surface of the substance comprises an organic material.

7. The method of claim 1, wherein the energy transfer at least includes an electromagnetic radiation in the frequency range from 100 MHz to 400 THz.

8. The method of claim 2, wherein the energy transfer at least includes transferring energy in a form selected from the group consisting of: a microwave electromagnetic radiation, and a far infrared electromagnetic radiation.

9. The method of claim 1, wherein the energy transfer at least includes transferring energy by a narrow bandwidth electromagnetic radiation with a photon energy at the edge of resonance electron transitions in the nanoobjects in the frequency range from 100 MHz to 400 THz.

10. The method of claim 1, wherein the energy transfer at least includes transferring energy from an electrical source by an electrical current selected from the group consisting of: a direct current that provides heat, an alternating current that provides heat, and any combinations thereof.

11. An apparatus, selected from the group consisting of:
i) a field effect transistor, a bipolar transistor, a solar cell, a laser, a light emitting diode, a photodiode, an electron source, a device for transforming and radiating electromagnetic fields, an electrical source, a capacitor, a device for surface studies, a computer related device, a device for hydrogen storage, a monitor, a flexible electronic device, a flexible optoelectronic device, an electrical connector, and a thermal connector, comprising any nanoobjects from the product obtained by the method of claim 1; and
ii) a device for sorting nanoobjects, comprising a) a substance selected from the group consisting of: a solid, a liquid, a soft matter, and any combinations thereof; b) a component providing contact between the surface of the said substance and an initial mixture that comprises nanoobjects with different electrical conductivities; c) a component providing an energy transfer to the said mixture with an amount of heat per unit of time obtained by the nanoonobjects dependent on their electrical conductivities; d) a component keeping at least some part of the contacting substance for at least some nonzero period of time during the energy transfer at a temperature (T) such that at least one condition is fulfilled from the group of conditions consisting of:
(1) the absolute difference between T and a melting transition temperature (Tₘ) of a part of the contacting substance, is less than a maximal absolute difference between temperatures of any parts of the nanoobjects (ΔT) at the surface during the energy transfer (|Tₘ−T|<ΔT),
(2) the absolute difference between T and an evaporation transition temperature (Tₑ) of a part of the contacting substance, is less than ΔT (|Tₑ−T|<ΔT),
(3) the absolute difference between T and an activation temperature of a chemical reaction that involves a part of the contacting substance (Tₑₛ), is less than ΔT (|Tₑₛ−T|<ΔT),
(4) the absolute difference between T and an activation temperature of a chemical reaction that involves the nanoobjects (Tₑₙ), is less than ΔT (|Tₑₙ−T|<ΔT);
e) a component which provides that at least some of the nanoonobjects are bonded after the start of the energy transfer to the contacting surface with an average strength of this bonding dependent on the nanoobjects electrical conductivities; f) a component providing a selective separation of mostly the weaker bonded and non-bonded nanoobjects from the said surface; and g) a component obtaining at least one product that comprises the nanoobjects with an average electrical conductivity that is different from the average electrical conductivity of the nanoobjects in the initial mixture.

12. The apparatus of claim 11, wherein the mixture comprises at least one semiconducting carbon nanotube.

13. The apparatus of claim 11, wherein
i) the method further comprises the step during which at least some part of the substance during the energy transfer at least once changes its phase from one phase from the group consisting of: a solid phase, a liquid phase, and a vapor phase to another phase from the same group; and
ii) the device for sorting nanoobjects further comprises: a component which provides that at least some part of the substance during the energy transfer at least once changes its phase from one phase from the group consisting of: a solid phase, a liquid phase, and a vapor phase to another phase from the same group.

14. The apparatus of claim 12, wherein i) the method further comprises the step during which at least some part of the substance during the energy transfer at least one time changes its phase from one phase from the group consisting of: a solid phase, a liquid phase, and a vapor phase, to another phase from the same group, and at least some part of the substance for at least some nonzero period of time during the energy transfer is kept at a temperature such that the difference between this temperature and at least one temperature selected from the group consisting of: a melting transition temperature of a part of the substance, and an evaporation transition temperature of a part of the substance, is less than a maximal difference between temperatures of any parts of the carbon nanotubes during energy transfer; and ii) the device for sorting nanoobjects further comprises: a component which provides that at least some part of the substance during the energy transfer at least one time changes its phase from one phase from the group consisting of: a solid phase, a liquid phase, and a vapor phase, to another phase from the same group, and at least some part of the substance for at least some (nonzero) period of time during the energy transfer is kept at a temperature such that the difference between this temperature and at least one temperature selected from the group consisting of: a melting transition temperature of a part of the substance, and an evaporation transition temperature of a part of the substance, is less than a maximal difference between temperatures of any parts of the carbon nanotubes during energy transfer.

15. The apparatus of claim 12, wherein
i) the method further comprises the step during which at least some part of the substance during the energy transfer at least once changes its phase from one phase from the group consisting of: a solid phase and a liquid phase, to another phase from the same group; and
ii) the device for sorting nanoobjects further comprises: a component which provides that at least some part of the substance during the energy transfer at least once changes its phase from one phase from the group consisting of: a solid phase and a liquid phase, to another phase from the same group.

16. The apparatus of claim 12, wherein the surface of the substance comprises an organic material.

17. The apparatus of claim 11, wherein
i) the method further comprises the energy transfer that at least includes an electromagnetic radiation in the frequency range from 100 MHz to 400 THz; and
ii) the device for sorting nanoobjects further comprises: a component providing the energy transfer that at least includes an electromagnetic radiation in the frequency range from 100 MHz to 400 THz.

18. The apparatus of claim 12, wherein
i) the method further comprises the energy transfer that at least includes transferring energy in a form selected from the group consisting of: a microwave electromagnetic radiation and a far infrared electromagnetic radiation; and
ii) the device for sorting nanoobjects further comprises: a component providing the energy transfer that at least includes transferring energy in a form selected from the group consisting of: a microwave electromagnetic radiation, and a far infrared electromagnetic radiation.

19. The apparatus of claim 11, wherein
i) the method further comprises the energy transfer that at least includes transferring energy by a narrow bandwidth electromagnetic radiation with a photon energy at the edge of resonance electron transitions in the nanoobjects in the frequency range from 100 MHz to 400 THz;
ii) the device for sorting nanoobjects further comprises: a component providing the energy transfer that at least includes transferring energy by a narrow bandwidth electromagnetic radiation with a photon energy at the edge of resonance electron transitions in the nanoobjects in the frequency range from 100 MHz to 400 THz.

20. The apparatus of claim 11, wherein
i) the method further comprises the energy transfer that at least includes transferring energy from an electrical source by an electrical current selected from the group consisting of: a direct current that provides heat, an alternating current that provides heat, and any combinations thereof;
ii) the device for sorting nanoobjects further comprises: a component providing the energy transfer that at least includes transferring energy from an electrical source by an electrical current selected from the group consisting of: a direct current that provides heat, an alternating current that provides heat, and any combinations thereof.

21. A method for increasing the portion of semiconducting nanoobjects in a mixture that comprises nanoobjects (objects with at least one spatial size in the range from 0.05 nm to 500 nm) with different electrical conductivities, comprising the steps of: a) providing placement of an initial mixture that comprises the nanoobjects with different electrical conductivities into a gas medium under pressure that is significantly lower than the normal atmospheric pressure (the pressure is less than 50 kPa); b) providing an energy transfer to the said mixture with an amount of heat per unit of time obtained by the nanoobjects dependent on their electrical conductivities at least before some of the nanoonobjects are modified into a form from the group consisting of: a gas, a liquid, a semiconductor, an insulator, and any combinations thereof; and c) obtaining at least one product that comprises the nanoobjects with a portion of the semiconducting nanoobjects that is significantly bigger than the portion of the semiconducting nanoobjects in the initial mixture.

22. The method of claim 21, wherein the mixture comprises at least one semiconducting carbon nanotube.

23. The method of claim 22, wherein the gas medium comprises at least one gas from the group consisting of: an oxygen gas (O₂), an ozone gas (O₃), a fluorine gas (F₂), an oxidizing agent gas, and any combinations thereof, with a partial pressure that is at least by 10% higher than the partial pressure of this gas in air.

24. The method of claim 22, wherein at least some part of the gas medium for at least some (nonzero) period of time during the energy transfer is kept at a temperature such that the absolute difference between this temperature and an activation temperature of a chemical reaction that involves the nanoobjects and the gas medium is less than a maximal absolute difference between temperatures of any parts of the nanoobjects after the start of the energy transfer.

25. The method of claim 22, wherein the energy transfer at least includes an electromagnetic radiation in the frequency range from 100 MHz to 400 THz.

26. The method of claim 21, wherein the energy transfer at least includes transferring energy by a narrow bandwidth electromagnetic radiation with a photon energy at the edge of resonance electron transitions in the nanoobjects in the frequency range from 100 MHz to 400 THz.

27. The method of claim 22, wherein the energy transfer at least includes transferring energy from an electrical source by an electrical current selected from the group consisting of: a direct current that provides heat, an alternating current that provides heat, and any combinations thereof.

28. An apparatus, selected from the group consisting of:
i) a field effect transistor, a bipolar transistor, a solar cell, a laser, a light emitting diode, a photodiode, an electron source, a device for transforming and radiating electromagnetic fields, an electrical source, a capacitor, a device for surface studies, a computer related device, a device for hydrogen storage, a monitor, a flexible electronic device, a flexible optoelectronic device, an electrical connector, and a thermal connector, comprising any nanoobjects from the product obtained by the method of claim 21; and
ii) a device for sorting nanoobjects, comprising a) a component providing placement of an initial mixture that comprises the nanoobjects with different electrical conductivities into a gas medium under pressure that is significantly lower than the normal atmospheric pressure (the pressure is less than 50 kPa); b) a component providing an energy transfer to the said mixture with an amount of heat per unit of time obtained by the nanoobjects dependent on their electrical conductivities at least before some of the nanoonobjects are modified into a form from the group consisting of: a gas, a liquid, a semiconductor, an insulator, and any combinations thereof; c) a component obtaining at least one product that comprises the nanoobjects with a portion of the semiconducting nanoobjects that is significantly bigger than the portion of the semiconducting nanoobjects in the initial mixture.

29. The apparatus of claim 28, wherein the mixture comprises at least one semiconducting carbon nanotube.

30. The apparatus of claim 29, wherein the gas medium comprises at least one gas from the group consisting of: an oxygen gas (O₂), an ozone gas (O₃), a fluorine gas (F₂), an oxidizing agent gas, and any combinations thereof, with a partial pressure that is at least by 10% higher than the partial pressure of this gas in air.

31. The apparatus of claim 29, wherein i) the method further comprises the step during which at least some part of the gas medium for at least some (nonzero) period of time during the energy transfer is kept at a temperature such that the difference between this temperature and an activation temperature of a chemical reaction that involves the nanoobjects and the gas medium is less than a maximal difference between temperatures of any parts of the nanoobjects during energy transfer; ii) the device for sorting nanoobjects, further comprises: a component which provides that at least some part of the gas medium for at least some (nonzero) period of time during the energy transfer is kept at a temperature such that the difference between this temperature and an activation temperature of a chemical reaction that involves the nanoobjects and the gas medium is less than a maximal difference between temperatures of any parts of the nanoobjects during energy transfer.

32. The apparatus of claim 29, wherein i) the method further comprises the energy transfer that at least includes an electromagnetic radiation in the frequency range from 100 MHz to 400 THz; ii) the device for sorting nanoobjects further comprises: a component providing the energy transfer that at least includes an electromagnetic radiation in the frequency range from 100 MHz to 400 THz.

33. The apparatus of claim 28, wherein i) the method further comprises the energy transfer that at least includes transferring energy by a narrow bandwidth electromagnetic radiation with a photon energy at the edge of resonance electron transitions in the nanoobjects in the frequency range from 100 MHz to 400 THz; ii) the device for sorting nanoobjects further comprises: a component providing the energy transfer that at least includes transferring energy by a narrow bandwidth electromagnetic radiation with a photon energy at the edge of resonance electron transitions in the nanoobjects in the frequency range from 100 MHz to 400 THz.

34. The apparatus of claim 29, wherein i) the method further comprises the energy transfer that at least includes transferring energy from an electrical source by an electrical current selected from the group consisting of: a direct current that provides heat, an alternating current that provides heat, and any combinations thereof; ii) the device for sorting nanoobjects further comprises: a component providing the energy transfer that at least includes transferring energy from an electrical source by an electrical current selected from the group consisting of: a direct current that provides heat, an alternating current that provides heat, and any combinations thereof.

35. A method for sorting nanoobjects (objects with at least one spatial size in the range from 0.05 nm to 500 nm), comprising the steps of: a) providing a contact between an initial mixture that comprises the nanoobjects with different electrical conductivities and an electrical conducting surface of a substance selected from the group consisting of: a solid, a liquid, a soft matter, and any combinations thereof; b) providing a deposition of a material in an electrolyte while driving an electrical current through the said contact at least during some (nonzero) period of time during this deposition with a thickness of the material layer deposited per unit of time on the nanoonobjects dependent on their electrical conductivities at least before some of the nanoonobjects are bonded to the surface with an average strength of this bonding dependent on the nanoobjects electrical conductivities; c) selectively separating mostly the weaker bonded and non-bonded nanoobjects from the surface; and d) obtaining at least one product that comprises the nanoobjects with an average electrical conductivity that is different from the average electrical conductivity of the nanoobjects in the initial mixture.

36. The method of claim 35, wherein the mixture comprises at least one semiconducting carbon nanotube.

37. The method of claim 36, further comprising the step of: providing the fixed contact by at least one of the means selected from the group consisting of: a mechanical force, a gravitational force, and an inertial force.

38. The method of claim 36, wherein the deposition of the material comprises an electroplating deposition providing an electrical potential difference in the electrolyte between at least some (nonzero) part of the mixture and at least one other electrode in the electrolyte.

39. An apparatus, comprising at least one device from the group consisting of:
i) a field effect transistor, a bipolar transistor, a solar cell, a laser, a light emitting diode, a photodiode, an electron source, a device for transforming and radiating electromagnetic fields, an electrical source, a capacitor, a device for surface studies, a computer related device, a device for hydrogen storage, a monitor, a flexible electronic device, a flexible optoelectronic device, an electrical connector, and a thermal connector, comprising any nanoobjects from the product obtained by the method of claim 35; and
ii) a device for sorting nanoobjects, comprising a) a component providing a contact between an initial mixture that comprises the nanoobjects with different electrical conductivities and an electrical conducting surface of a substance selected from the group consisting of: a solid, a liquid, a soft matter, and any combinations thereof; b) a component providing a deposition of a material in an electrolyte while driving an electrical current through the said contact at least during some (nonzero) period of time during this deposition with a thickness of the material layer deposited per unit of time on the nanoonobjects dependent on their electrical conductivities at least before some of the nanoonobjects are bonded to the surface with an average strength of this bonding dependent on the nanoobjects electrical conductivities; c) a component selectively separating mostly the weaker bonded and non-bonded nanoobjects from the surface; and d) a component obtaining at least one product that comprises the nanoobjects with an average electrical conductivity that is different from the average electrical conductivity of the nanoobjects in the initial mixture.

40. The apparatus of claim 39, wherein the mixture comprises at least one semiconducting carbon nanotube.

41. The apparatus of claim 40, wherein i) the method further comprises the step of: providing the fixed contact by at least one of the means selected from the group consisting of: a mechanical force, a gravitational force, and an inertial force; ii) the device for sorting nanoobjects further comprises: a component providing the fixed contact by at least one of the means selected from the group consisting of: a mechanical force, a gravitational force, and an inertial force.

42. The apparatus of claim 40, wherein the deposition of the material comprises an electroplating deposition with providing an electrical potential difference in the electrolyte between at least some (nonzero) part of the mixture and at least one other electrode in the electrolyte.
